(19) United States
(12) Patent Application Publication
(10) Pub. No.: US 2005/0265158 A1
(43) Pub. Date: Dec. 1, 2005

(54) Optical disk apparatus and optical-disk image forming method

(75) Inventors: Takeyuki Minamimoto, Tachikawa-shi (JP); Satoru Matsumura, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/947,410

(22) Filed: Sep. 23, 2004

(30) Foreign Application Priority Data
May 27, 2004 (JP) 2004-157485

(51) Int. Cl. G11B 5/09

(52) U.S. Cl. 369/47.1; 369/53.1; 369/59.1

(57) ABSTRACT

An optical disk apparatus has a rotation section which rotates an optical disk having a photoimageable layer, a pickup section having a laser radiation section which irradiates the laser light onto the photoimageable layer, a driving section for the pickup section, an irradiation driving section which supplies a driving current to the laser radiation section, a generating section which receives image information, adds identification information for the image information thereto, and generates drive information for the pickup section and the irradiation driving section, based on the image information, and a control section which, in accordance with the drive information, controls the position of the laser light by controlling the driving section, and controls gradation of a visualized image, to render a visualized image on the optical disk in accordance with the image information and the identification information.

### CROSS-REFERENCE TO RELATED APPLICATIONS

This application is based upon and claims the benefit of priority from prior Japanese Patent Application No. 2004-157485, filed May 27, 2004, the entire contents of which are incorporated herein by reference.

### BACKGROUND OF THE INVENTION

1. Field of the Invention

The present invention relates to optical disk apparatuses, such as DVDs (Digital Versatile Disks) and CDs (Compact Disks). More particularly, the present invention relates to an optical disk apparatus for forming images of labels of optical disks together with identification information of the labels by using laser light generated by the optical disk apparatus, and further relates to an optical-disk image forming method.

2. Description of the Related Art

Recently, optical disks, such as DVDs, have been being spreading as recording media. In disks of this kind, usually, a label indicative of contents is recorded on the surface of each disk. In general cases, this label is separately created and adhered to the disk or is directly printed on the disk by a printer. However, attempts have been made to form a layer of material having color which is variable by laser light and to form a label image by laser light from an optical disk apparatus.

Prior art of this kind of disk apparatus (Jpn. Pat. Appln. KOKAI Publication NO. 2002-203321) discloses an example in which an image is formed on a color-variable layer by the power of laser light emitted from an optical pickup, i.e., gradation of images can be expressed in correspondence with the intensity of the laser light.

Other prior art of this kind of disk apparatus (Jpn. Pat. Appln. KOKAI Publication NO. 2004-5848) discloses an example in which, similar to the above, an image is formed on a color-variable layer by the power of laser light emitted from an optical pickup. That is, gradation data is prepared for every turn of the disk, and the image is formed in correspondence with the intensity of the laser light.

However, in the prior art of these optical disk apparatuses described above, there is a problem when a user sees a label image on an optical disk after the image formation. That is, it is difficult to make an operation of calling the same label image from a storage area again and forming the image on another optical disk.

### BRIEF SUMMARY OF THE INVENTION

According to an aspect of the present invention, there is provided an optical disk apparatus comprising: a rotation section which rotates an optical disk having a photoimageable layer that is made imageable by laser light; a pickup section having a laser radiation section which irradiates the laser light onto the photoimageable layer; a driving section which drives the pickup section; an irradiation driving section which supplies a driving current to the laser radiation section to drive the laser radiation section to irradiate the laser light; a generating section which receives image information, adds identification information for the image information to the image information, and generates drive information for the pickup section and the irradiation driving section, based on the image information; and a control section which controls the position of the laser light by controlling the driving section as well as gradation of a visualized image by controlling the irradiation driving section, in accordance with the drive information generated by the generating section, to render a visualized image on the optical disk in accordance with the image information and the identification information for the image information.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a block diagram showing an example of the configuration of an optical disk apparatus according to an embodiment of the present invention;

FIG. 2 is a system view showing an example of the configuration of a disk drive section of the optical disk apparatus according to the embodiment of the present invention;

FIG. 3 is a plan view showing an example of a label with identification information of an optical disk to be rendered by the optical disk apparatus according to the embodiment of the present invention;

FIG. 4 is a cross-sectional view showing an example of the configuration of an optical disk having a photoimageable layer which is handled by the optical disk apparatus according to the embodiment of the present invention;

FIG. 5 is a flowchart showing an example of a visualizing process of the optical disk apparatus according to the embodiment of the present invention;

FIG. 6 is a flowchart showing another example of a visualizing process of the optical disk apparatus according to the embodiment of the present invention; and

FIG. 7 is an explanatory view for a distribution of photoimageable layers corresponding to R, G, and B in an optical disk handled by the optical disk apparatus according to the embodiment of the present invention.

### DETAILED DESCRIPTION OF THE INVENTION

An embodiment of the present invention will be described in detail below with reference to the accompanying drawings.

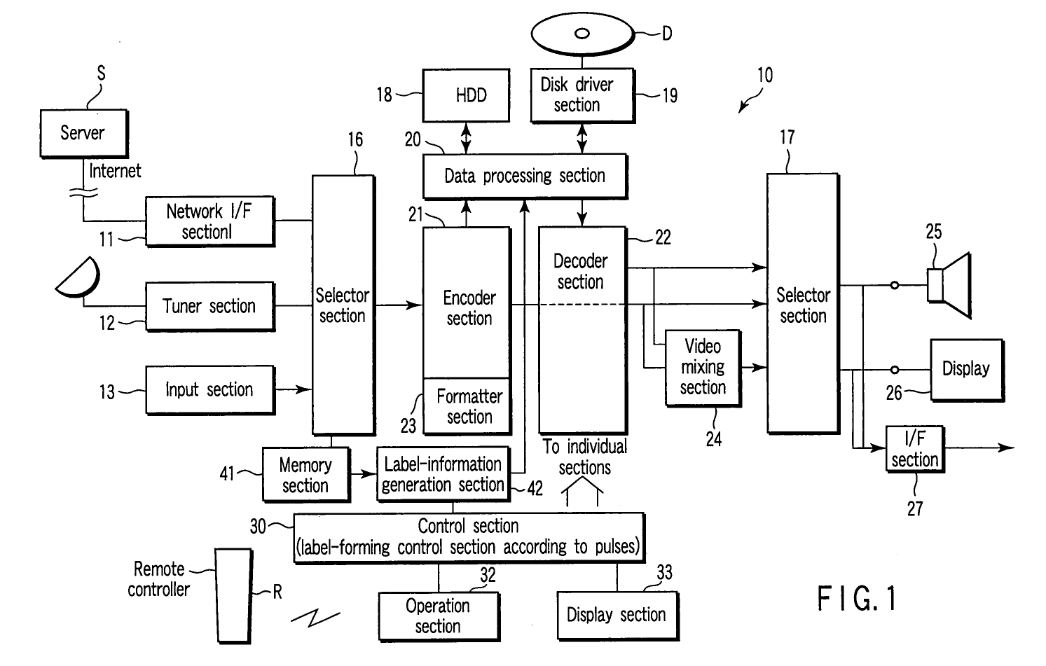

More specifically, an optical disk apparatus of the present invention will be described in detail with reference to an optical disk apparatus 10 as an example that is a composite recording/playback apparatus as shown in FIG. 1.

<Optical Disk Apparatus According to an Embodiment of the Present Invention>

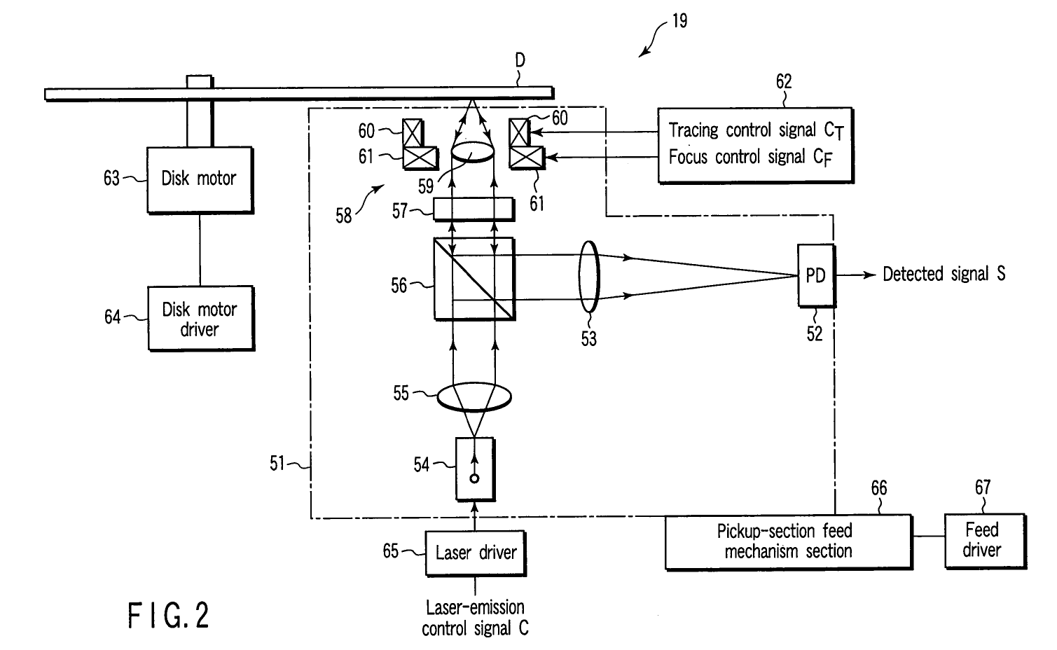

First, a configuration of the optical disk apparatus according to the present invention will be described with reference to the drawings. FIG. 1 is a block diagram showing an example of the configuration of the optical disk apparatus 10 according to the embodiment of the invention. FIG. 2 is a system view showing an example of a configuration of a disk drive section of the optical disk apparatus 10 according to the embodiment of the invention.

(Configuration)

According to the present embodiment, the optical disk apparatus 10 is disclosed as an apparatus capable of handling both of a DVD-RAM (random access memory) and hard disk as a recording medium. However, the hard disk or DVD-RAM may be replaced with, for example, a recording medium formed of a semiconductor memory. In FIG. 1, individual blocks are broadly grouped into two: one group of major blocks of a recording section on the lefthand side, and the other group of major blocks of a reproducing section on the righthand side.

The control section 30 includes a label ID control management section and a label forming section, and further performs recording and deal per play unit, and includes buffer circuits and error correction section.

The optical disk apparatus 10 shown in FIG. 1 has disk drive sections of two types, namely, a disk drive section 19 and a hard disk drive section 18. The disk drive section 19 rotationally drives an optical disk D as a first medium used as an information recording medium capable of configuring a video file, and executes read and write of information. The hard disk drive section 18 drives a hard disk serving as a second medium. A control section 30 controls total operation and is hence connected to individual sections. For example, the control section 30 can supply record data to, for example, the disk drive section 19 and the hard disk drive section 18, and can receive reproduced signals.

Referring to FIG. 2, the disk drive section 19 has, for example, various systems for the optical disk D, such as a rotation control system, a laser driving system, and an optical system. More specifically, as shown in FIG. 2, the disk drive section 19 has a disk motor 63 which rotates the optical disk D at a predetermined rotational velocity; a disk motor driver 64 which supplies the disk motor 63 with a driving current under the control of the control section 30 thereby to drive the disk motor 63; an optical pickup 51; a tracking control section/focus control section 62 that receives a tracking error signal and a focus error signal, supplies an actuator 58 described below with a tracking control signal C_{T} and a focus control signal C_{F}, and thereby controls tracking and focusing of an objective lens 59; a pickup-section feed mechanism section 66 which moves the optical pickup 51 along the radial direction of the optical disk D; and a feed driver 67 which supplies the driving current to the pickup-section feed mechanism section 66.

As shown in FIG. 2, the optical pickup 51 of the optical disk apparatus 10 according to the invention has the actuator 58, which has the objective lens 59. The actuator 58 has an actuator drive coil 60 in the track direction and an actuator drive coil 61 in the focus direction. In the configuration, servo control is enabled due to the individual tracking control signal C_{T} and focus control signal C_{F} being supplied from the tracking control section/focus control section 62.

The optical pickup 51 performs both light reception and radiation with the function of a beamsplitter 56 or the like. A radiation of laser light emitted from a laser diode 54 corresponding to a control signal from a laser driver 65 travels through a collimating lens 55, the beamsplitter 56, a one-quarter waveplate 57, and the like, is focused by the objective lens 59, and is thus directed to irradiate a predetermined region of the optical disk D. Further, reflected light from the optical disk D is expanded by the objective lens 59, split by the beamsplitter 56 to the side of a focusing lens 53, and supplied to a photodetector 52. The photodetector 52 supplies a detected signal S. A tracking error signal and a focus error signal are supplied to the tracking control section 62 and the focus control section 62 via an RF amplifier not shown, and the detected signal S for generating a reproduction signal is supplied to a data processing section 20.

In addition, the optical disk apparatus according to the invention has a write APC (Auto Power Controller) circuit not shown. The APC circuit receives a front monitor signal from a front monitor not shown of the optical pickup 51 and supplies the laser driver 65 with an appropriate control signal C corresponding to the front monitor signal whereby to control the laser driver 65. In particular, the APC circuit controls whether laser light is appropriately output in the event of, for example, writing to the optical disk D and label image forming to be described later.

Major configuration elements of the optical disk apparatus 10, shown in FIG. 1, are an encoder section 21 constituting the video recording side, a decoder section 22 constituting the reproducing side, and the control section 30 for controlling operation of the entire apparatus. Specifically, the optical disk apparatus 10 has an input-side selector section 16 and an output-side selector section 17. The input-side selector section 16 is connected to a network I/F section 11, a tuner section 12, and an input section 13, whereby to output signals to the encoder section 21 or a memory section 41 that stores data such as image information. The optical disk apparatus 10 further has a formatter section 23 connected to the encoder section 21, the data processing section 20 for receiving an output of the encoder section 21, and the hard disk drive section 18 and disk drive section 19 connected to the data processing section 20. The optical disk apparatus 10 has the decoder section 22 that performs decoding upon receiving signals from the hard disk drive section 18 and the disk drive section 19. Also, the optical disk apparatus 10 has a video mixing section 24 that receives signals from the encoder section 21, the decoder section 22, the control section 30, and a display section 31. An output of the output-side selector section 17 is connected to a speaker 25 and a display section 26, or is supplied to an external device through an interface section 27 for making communication with an external device. The optical disk apparatus 10 further has an operation section 32 that is connected to the control section 30 whereby to receive user operations or operations of a remote controller R.

The remote controller R enables substantially the same operations as the operation section 32 provided in a main body of the optical disk apparatus 10. Specifically, the remote controller R enables various operations such as record/reproduction instruction to, for example, the hard disk drive section 18 and the disk drive section 19, edit instruction, tuner operation, and setting of reserved video recording. The optical disk apparatus 10 further has the memory section 41 which receives, for example, outputs of image signals from the selector section 16 and stores the outputs; and a label-information generating section 42 generating section 42 for generating, for example, label information and drive information corresponding to image signals or the like.

(Basic Operations)

First, the following will provide overviews of an optical-disk reproducing process and an optical-disk recording process to be performed in the optical disk apparatus configured as described above. The optical-disk reproducing process is performed in the following manner. Under the control of the control section 30, the optical disk D rotated at a predetermined velocity by the disk motor 63 controlled by the disk motor driver 64 is irradiated with laser light driven by the laser driver 65. Reflected light of the laser light is detected by the photodetector 52 of the optical pickup 51, and the detected signal S corresponding thereto is output. The detection signal S is supplied to an RF amplifier included in the data processing section 20. An RF signal having been output from the RF amplifier is supplied to the decoder section 22 and the control section 30. Concurrently, a focus error signal and a tracking error signal, which are used as servo-driving signals, generated in the RF amplifier included in the data processing section 20, are supplied to the focus control section 62 and the tracking control section 62, respectively. In the data processing section 20, RF signals are decoded, and decoded signals are either blended by the video mixing section 24 or are directly output to the outside via the interface section 27. The control section 30 generates a control signal for controlling the rotation of the disk motor 63, whereby controlling the rotation of the disk motor 63.

Further, in the optical disk unit configured as described, an optical-disk recording process is performed in the following manner. Under the control of the control section 30, data supplied through, for example, the input section 13 and the selector section 16 is temporarily stored into the memory section 41 and is thereafter supplied to the encoder section 21 to be encoded, and encoded data is output. In accordance with the encoded output and the output of the control section 30, a driving current of the laser driver 65 is supplied to the optical pickup 51. In the optical pickup 51, laser light corresponding to the driving current is emitted from the mounted laser diode 54 and is irradiated to the storage area of the optical disk D rotated at a predetermined velocity by the disk motor 63. In this manner, the recording process is performed.

(Detail Operation)

Recording Process, Etc.

The operations of the optical disk apparatus 10 configured as described above will now be described in detail hereinbelow. First, operations primarly in the recording event, including other embodiments, will be described. In the input side of the optical disk apparatus 10, the network I/F section 11 is connected to, for example, a server S through the Internet whereby to download contents information and the like. The tuner section 12 selects a channel of a broadcast signal through an antenna, demodulates the signal, and outputs a video signal and an audio signal. The input section 13 receives from the outside various signals, such as brightness signals, color difference signals, video signals for a composite image or the like, and audio signals. These signals are input under control of the selector section 16 controlled by, for example, the control section 30, and selectively supplied to the encoder section 21. Thus, the encoder section 21 receives through the selector section 16 input signals, such as an external analog video signal and an external analog audio signal from the input section 13, or an analog video signal and an analog audio signal from the tuner section 12.

The encoder section 21 has video and audio analog/digital converters, a video encoder, and an audio encoder. The analog/digital converters digitize an analog video signal and analog audio signal having been input from the selector section 16. Additionally, the encoder section 21 includes a sub-picture video encoder. An output of the encoder section 21 is transformed by the by the formatter section 23 including a buffer memory into a predetermined DVD-RAM format and supplied to the control section 30.

When a directly compressed digital video signal, digital audio signal, or the like is directly input, the encoder section 21 is capable of directly supplying the compressed digital video signal, digital audio signal, or the like to the formatter section 23. In addition, the encoder section 21 is capable of directly supplying an analog-digital-converted digital video signal, audio signal, and the like to the video mixing section 24 or the selector section 17.

In the video encoder included in the encoder section 21, a digital video signal is converted into a digital video signal compressed at a variable bitrate based on the MPEG2 or MPEG1 standard. A digital audio signal is converted into a digital audio signal at a fixed bitrate based on the MPEG or AC-3 standard, or is converted into a linear-PCM digital audio signal.

Suppose that a sub-picture video signal has been input from the input section 13, or suppose that a DVD video signal having such a data structure is broadcast and the signal is received by the tuner section 12. In this case, the sub-picture video signal in the DVD video signal is encoded by the sub-picture video encoder (run length encoding) into a sub-picture video bitmap.

The encoded digital video signal, digital audio signal, and sub-picture video data are packed by the formatter section 23 into a video pack, audio pack, and sub-picture video pack. Further, the packs are aggregated into a format standardized by DVD-recording standards (standards for recording into, for example, a DVD-RAM, DVD-R, and DVD-RW).

In the apparatus shown in FIG. 1, the information (such as video, audio, and sub-picture video data packs) formatted by the formatter section 23 and created management information can be supplied to the hard disk drive section 18 or the disk drive section 19 through the control section 30. Thereby, the information can be recorded into the hard disk drive section 18 or the optical disk D. In addition, information recorded into the hard disk drive section 18 or the optical disk D can be recorded into the optical disk D or the hard disk through the control section 30 and the disk drive section 19.

Edit Process, Etc.

Next, a description will be made in detail primarily regarding the process of editing recorded information, including another embodiment. An edit process can be performed in such a manner that video objects of multiple broadcast programs recorded in the hard disk or the optical disk D are partly deleted and connected to a different object of a broadcast program.

To facilitate the edit process, the control section 30 includes an MPU (microprocessing unit) or a CPU (central processing unit); a ROM into which control programs and the like are written; and a RAM for providing a work area necessary for program execution.

Preferably, in accordance with control programs stored in the ROM, the MPU of the control section 30 uses the RAM as a work area whereby, for example, to perform read/write address determination in the disk drive section 19, defective location detection, unrecorded area detection, video-recording information position setting, UDF recording, and AV address setting. The control section 30 additionally has a control function for a label ID (identification information) management section and a label image forming processing section described below.

By way of still another embodiment, the control section 30 preferably has components not shown, such as a directory detector section, and a management information control section serving for the edit event and the video-recording event. Further, the control section 30 preferably has components not shown, such as a VMG (total video management) information creating section, a copy-related information sensing section, a copy-and-scrambling information processing section (RDI processing section), a packet header processing section, a sequence header processing section, and an aspect ratio information processing section.

In the event of the edit process or another process, the contents to be notified to a user in the MPU execution results are either displayed on the display section 31 of the optical disk apparatus or displayed as OSDs (on-screen displays) on the display section 26. The control section 30 further has the operation section 32 which feeds operation signals for operating the apparatus. Preferably, the operation section 32 is further provided with the remote controller R.

The control section 30 controls the disk drive section 19, hard disk drive section 18, control section 30, encoder section 21, and/or decoder section 22, at timings based on time data from an STC (system time clock) not shown. Ordinarily, the video-recording operation and the playback operation are executed in synchronization with time clock data from the STC. The other processes may be executed at timings independent from the STC.

Reproducing Process, Etc.

Next, a description will now be made in detail primarily regarding the process of reproducing recorded information, including another embodiment. The decoder section 22 has a separator, a memory, a V decoder, an SP decoder, and an A decoder. The separator separates and takes out each pack from a signal of a DVD format having a pack structure. The memory is used during the execution of pack separation and other signal processes. The V decoder decodes main video image data (video pack contents) separated by the separator. The SP decoder decodes sub-picture video data (sub-picture video pack contents) separated by the separator. The A decoder decodes audio data (audio pack contents) separated by the separator. Additionally provided is a video processor that appropriately mixes decoded sub-picture images with decoded main video images whereby to output images in which sub-pictures such as menus, highlight buttons, and subtitles are superimposed with the main video image.

An output video signal of the decoder section 22 is input to the video mixing section 24. The video mixing section 24 performs mixing of text data. The video mixing section 24 is coupled with lines for directly taking signals from the tuner section 12 and the input section 13, for example. The video mixing section 24 is connected to a frame memory not shown that is used as a buffer. When an output of the video mixing section 24 is supplied to the selector section 17 and is selected by the selector section 17, the output sis either displayed on the display section 26 or is supplied to the external device through the I/F (interface) section 27.

An output audio signal of the decoder section 22 is converted by a digital-analog converter not shown to an analog signal, and the analog signal is supplied to the speaker 25 through the I/F section 27, or is supplied to the external device through the I/F section 27. The selector section 17 is controlled by a select signal sent from the control section 30. This enables the selector section 17 to directly select a signal passed through the encoder section 21 when directly monitoring a digital signal sent from the tuner section 12 or the input section 13.

In the formatter section 23 of the encoder section 21, individual separation information (information in the event of, for example, GOP-top interruption) is periodically sent to the MPU of the control section 30 during video recording. The separation information has, for example, the number of VOBU packs, an end address of I-picture from the top of the VOBU, and the playback time of VOBU.

Concurrently, information from the aspect information processing section is sent to the MPU at the time of video-recording initiation, and the MPU creates VOB stream information (STI). The STI stores data such as resolution data and aspect data, and initializations are performed in the individual decoder sections in accordance with the STI.

The control section 30 receives data in VOBU units from the formatter section 23 of the encoder section 21, and supplies the data to the disk drive section 19 or the hard disk drive section 18. The MPU of the control section 30 creates management information necessary for the reproduction of stored data and sends the created management information to the control section 30 upon recognition of a command for data-recording termination. Thereby, the management information is recorded into the disk. Thus, when encoding is being executed, the MPU of the control section 30 receives information (such as the separation information) in units of data from the encoder section 21. In addition, at the time of recording initialization, the MPU of the control section 30 recognizes the management information (file system) having been read from the optical disk and the hard disk, recognizes an unrecorded area of the each individual disk, and sets the recording area to the disks through the control section 30.

In addition, as described below, the control section 30 is capable of accessing, for example, a server of contents information provided on the Internet via the network I/F section 11, downloading the contents information, and recording the contents information into a storage area of the hard disk drive section 18. In response to user operations, the contents information recorded into the storage area of the hard disk drive section 18 is read from the hard disk drive section 18, and is decoded by the decoder section 22. The contents information is then appropriately selected by the selector section 17 through the video mixing section 24, and is then supplied to the speaker 25 and the display section 26 or through the I/F 27 to the external device.

As described above, the optical disk apparatus 10 of the present embodiment is of the type having a comprehensive functionality that performs the recording/reproducing processes with the optical disk D (or hard disk) for many sources. The label image forming process for the optical disk D in the optical disk apparatus 10 will now be described below.

<Optical-Disk Label Image Forming Process>

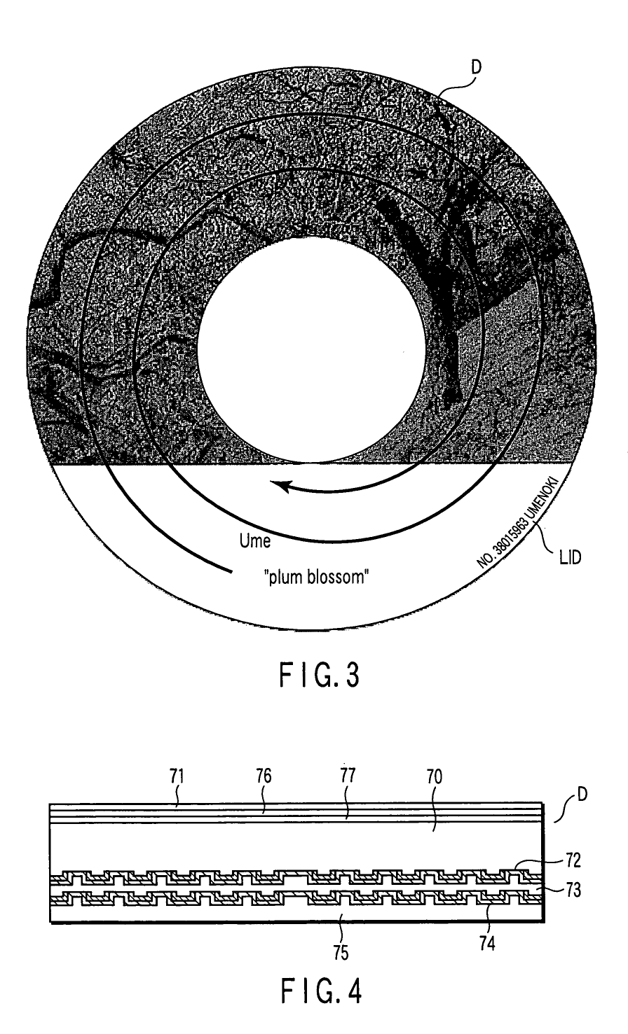

The optical disk apparatus 10 of the one embodiment according to the present invention performs not only the recording/reproducing processes described above, but also the optical-disk label image forming process using the laser light emitted from the laser diode 54. In this process, identification information such as a name of image information used as a label image is printed as an image on one or both of the inner and outer circumferential sides. The optical-disk label image forming process of one embodiment according to the present invention will be described in detail hereinbelow with reference to the drawings. FIG. 3 is a plan view showing an example of a label of an optical disk with identification information LID, which is to be rendered by the optical disk apparatus according to the embodiment of the invention. FIG. 4 is a cross-sectional view showing an example of a configuration of an optical disk having a photoimageable layer that is handled by the optical disk apparatus according to the embodiment of the invention.

The label image may be of the type to be supplied to the input section 13 from an external device, such as a personal computer. Alternatively, the label image may be of the type obtained in such a manner that video image information of a broadcast signal selected and demodulated by, for example, the tuner section 12 is stored into, for example, the hard disk drive section 18, and a static image obtained therefrom is processed.

First, as shown in FIG. 4, the optical disk D, such as a DVD, should have a photoimageable layer 76, which is made imageable by the laser light, to form the label image as shown in FIG. 3. The optical disk D is of a one-side two-layer type having the photoimageable layer 76. In FIG. 3, the optical disk D has a reflecting layer 77, the photoimageable layer 76, and a transparent protective film layer 71 on a transparent-resin substrate 70. In addition, the optical disk D has a first recording layer 72, an intermediate layer 73, a second recording layer 74, and a transparent protective film layer 75.

The optical disk apparatus 10 performs label image forming in a manner described hereafter for the optical disk D having the photoimageable layer 76 described above. The label image as shown in FIG. 3 may be of the type to be supplied to the input section 13 from an external device, such as a personal computer. Alternatively, the label image may be of the type obtained in such a manner that video image information of a broadcast signal selected and demodulated by, for example, the tuner section 12 is stored into, for example, the hard disk drive section 18, and a static image obtained therefrom is processed.

First, the case where the image information is provided from, for example, an external personal computer to the input section 13 will be described hereafter. In particular, a description will be provided with reference to a case where information of an ordinary image format, such as JPEG or MPEG image information, is provided. Under the control of the control section 30, the image information supplied from the input section 13 is retrieved from the selector section 16 and stored into the memory section 41. The image information is then supplied to the label-information generating section 42 in accordance with the user's operation through the operation section 32 and operation of the control section 30. In the label-information generating section 42, when the image information for the label image represents an ordinary rectangular image, a masking process is applied to the label image information, as shown in FIG. 3. In this stage, identification information LID which is a name of image information numbered according to the user's operation or automatically according to a predetermined rule is added to one or both of inner and outer circumferential areas or any other area. Further, the image information added with identification information LID is transformed into per-rotation image information.

More specifically, ordinary image information is configured as individual gradation information in terms of x-coordinate and y-coordinate. However, to form the image information in the form of a spiral or concentric circle on the photoimageable layer of the rotating optical disk, the image information is transformed into a form identifying that “gradation information is at what angle and at what rotation on the disk.” The transformation process is preferably performed using a preliminarily created transformation table to transform the ordinary image information into the form of “multiple items of gradation information at each angle per rotation on the disk.”

Next, based on the individual gradation information per rotation of the optical disk, the label-information generating section 42 generates control signals corresponding to the image information in the form of the individual per-rotation gradation information under the control of the control section 30. The control signals are a control signal for the feed driver 67 which supplies the driving current to the pickup-section feed mechanism section 66 of the optical pickup 51; a control signal for the disk motor driver 64 which supplies the driving current to the disk motor 63; and a laser-emission control signal C to be supplied to the laser driver 65 which supplies the driving current to the laser diode 54. Due to these control signals being supplied to individual sections, the individual sections are controlled under the control of the control section 30. At this time, even when a formed image M is a continuous photoimageable region, the driving current from the laser driver 65 does not take the mode of a DC driving current, but takes the mode of sequential pulse signals. This enables the power of laser light to be maximized and enables secure label image forming. Specifically, if the driving current of the laser diode is supplied to the laser diode 54 in the singular pulse or the continuous DC mode, the maximum emission power is as low as about ½ in value of the power in the case where the driving current of the laser diode 54 in the form of a continuous pulse signal is output.

Due to the above-described laser light emission being applied, the photoimageable layer 76 of the optical disk D is changed from the transparent state to an opaque state corresponding the light quantity or heat of the laser light. Thereby, as shown in FIG. 3, the label image with identification information LID (e.g., name of image information or a serial number), which has gradations according to the intensity of the laser light, is formed into a spiral or concentrically circular state. This identification information LID of the label image makes it easy to use a label image multiple times, and label images can be managed greatly easily.

It is further preferred that multiple shots of laser-light irradiation are applied in units of the rotation to even more securely perform image forming of the photoimageable layer 76. More specifically, not only the concentration gradients are represented at a single shot of irradiation by changing the intensity of the laser light, but also the number of shots of irradiation to the same region be increased to, for example, two, five, and ten in accordance with the concentration of the gradation image whereby to enhance securability of the concentration representation.

The optical disk apparatus uses the laser diode for a laser radiation section for laser light used for the information recording process and reproducing process. Thereby, a dedicated optical-disk label printer section need not be provided, and configurations of the disk rotation section, pickup section, and pickup driving section, and control section can be sharedly used.

### Other Embodiments

In addition, it is preferred that image information in the form of individual per-rotation gradation information (with identification information LID of the image information provided in one or both of inner and outer circumferential areas or in another area) is directly received from the outside and used through the input section 13 and the like. In this case, the above-described process of transforming image information is performed in, for example, a PC (personal computer), which is an external device connected to the input section 13. Thereby, image information in the form of per-rotation gradation information corresponding to the image information is retrieved and supplied to the input section 13. In this case, the above-described transformation process need not be performed in the label-information generating section 42. In accordance with the supplied individual gradation information per rotation of the optical disk D, control signals corresponding thereto are generated. The control signals are a control signal for the feed driver 67 which supplies the driving current to the pickup-section feed mechanism section 66 of the optical pickup 51; a control signal for the disk motor driver 64 which supplies the driving current to the disk motor 63; and a laser-emission control signal C to be supplied to the laser driver 65 which supplies the driving current to the laser diode 54. By using these control signals, a label image is generated as in the manner described above.

The following is also preferred. Data such as the image information and the image information in the form of the individual gradation information per-rotation of the optical disk D is not received from the outside. However, for example, a video signal of a broadcast signal selected and demodulated in the tuner section 12 is once stored in, for example, the memory section 41 or the hard disk drive section 18. Then, under the control of the control section 30, the stored information is read out in response to user operations performed through the operation section 32, and the image information displayed on the display section 26 is edited as operation information mixed in the video mixing section 24. It is further preferable that label image information which was once used is stored, together with identification information LID, into a storage area of the memory section 41, hard disk drive section 18, or the like. In accordance with a user's operation, a list of label image information is displayed, together with identification information LID, on the display 26 to allow the user to make an operation for an arbitrary selection.

Alternatively, with respect to image information having no identification information, the user can arbitrarily select a static image in the video image information from the broadcast signal and arbitrarily select region tat is used as a label image. Further, according to a user's operation, identification information LID for the image information is arbitrarily given or identification information LID as a name of the image information automatically numbered according to a predetermined rule is added. In this case, the region becomes doughnut-shaped image region partly cutaway on the optical disk D shown in FIG. 3, and in accordance with the procedure described previously, the image information is transformed into the image information in the form of the individual gradation information per-rotation of the optical disk D to be used in the label image forming process. Of course, the video image source is not limited only to that selected trough the tuner section 12, but it may be image information sent from the server S via the Internet through the network I/F section 11. Alternatively, it may preferably be a user's own image supplied from, for example, a digital camera through the input section.

Thus, an arbitrary image can be freely formed as a label image of the optical disk D. At this time, the image is formed with identification information LID added as shown in FIG. 3. Thus, it is possible to store a library of image information of title images of programs which the user successively watches, user's own portraits, and the like, in a storage area. An originality-rich DVD library can be created with ease.

Color Image Forming with Image Selection and Shape Selection

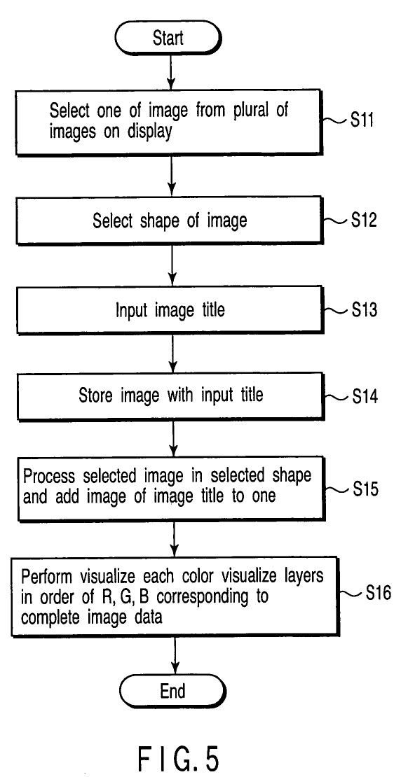

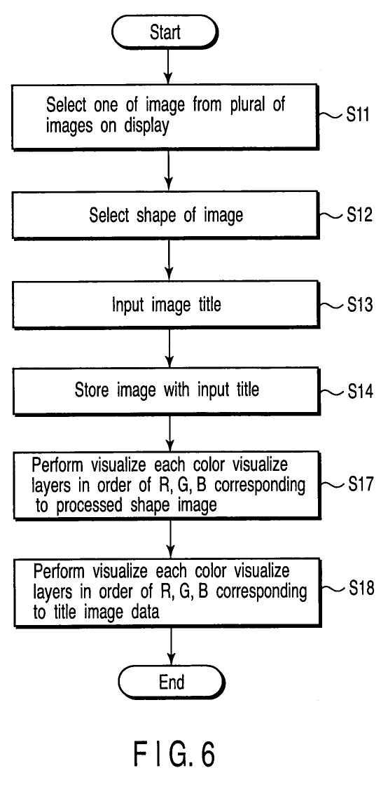

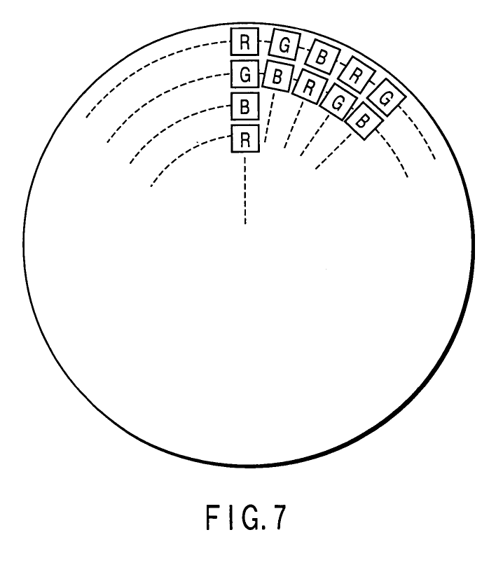

Next, a color image forming process with image selection and shape selection in the optical disk apparatus according to the present invention will be described in detail with reference to flowcharts shown in FIGS. 5 and 6 and to FIG. 7. Specifically, in the optical disk apparatus according to the present invention, for example, plural items of image information stored in advance in the hard disk drive section 18 or the like are output to the display 26 in FIG. 1 or the like, and one of the plural images on the operation screen is selected in accordance with a user's operation (S11). Similarly, plural images of shapes as candidates are displayed on the operation screen of the display 26 shown in FIG. 1 or the like, so that a shape of the image for the disk is selected in accordance with a user's operation (S12). Specifically, the shapes may be a sector shape, rectangular shape, semi-circular shape, and the like. Further, a title to be linked to the selected image is input in accordance with a user's operation on the remote controller R or the like (S13). Then, the image information, shape, and the like are stored into, for example, the hard disk drive section 18, with the image information, shape, and the like linked to the title information (S14).

The selected image is thereafter processed into the selected shape, and the image of the selected image title is further added thereto (S15). Further, corresponding to the image information thus completed, laser light is irradiated on photoimageable layers corresponding to individual color images, as schematically shown in FIG. 7, by the operation of the control section 30 and by the laser control function of the pickup included in the disk drive section 19. Preferably in this case, the photoimageable layers corresponding to individual color elements are visualized by laser light, for example, in the order of R, G, and B (S16). However, the present invention is not limited hitherto.

As shown in FIG. 6, the photoimageable layers corresponding to individual color elements are visualized by laser light in the order of R, G, and B, firstly in accordance with only the image information processed suited for a shape (S17). Thereafter, in accordance with title image information, the photoimageable layers corresponding to individual color elements are further visualized by laser light, for example, in the order of R, G, and B (S18).

The above embodiments have been described with reference to an optical disk apparatus as a composite machine including a hard disk recorder and the like. The present invention is not limited hitherto. For example, equivalent processes are possible in an optical disk recording/playback apparatus which handles with only optical disks.

In the optical disk apparatus, as specifically described above, identification information which is the name of image information of a label image is formed as a image on one or both of inner and outer circumferential areas of a label surface of an optical disk, when forming the label surface on an optical disk by laser light. By referring to the identification information, users can retrieve the same image information, for example, from a storage area of the optical disk apparatus even with respect to an optical disk on which image formation has already been finished, and the image information can be formed as an image on another optical disk.

Persons skilled in the art can realize the present invention according to the various embodiments described above. However, further various modifications of these embodiments will readily occur to the persons skilled in the art. The present invention therefore can be applied various embodiments without inventive abilities.

For example, identification information of image information can be inserted into a label image in any stage of processes. The same functions and advantages can be obtained in such a manner that, after image forming of a label image, identification information is formed as an image added to the label image. The present invention thus covers a broad scope which does not contradict the principles and novel features disclosed herein, and hence is not limited only to the embodiments described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical disk apparatus comprising:
a rotation section which rotates an optical disk having a photoimageable layer that is made imageable by laser light;
a pickup section having a laser radiation section which irradiates the laser light onto the photoimageable layer;
a driving section which drives the pickup section;
an irradiation driving section which supplies a driving current to the laser radiation section to drive the laser radiation section to irradiate the laser light;
a generating section which receives image information, adds identification information for the image information to the image information, and generates drive information for the pickup section and the irradiation driving section, based on the image information; and
a control section which controls the position of the laser light by controlling the driving section as well as gradation of a visualized image by controlling the irradiation driving section, in accordance with the drive information generated by the generating section, to render a visualized image on the optical disk in accordance with the image information and the identification information for the image information.

2. The apparatus according to claim 1, wherein the generating section transforms the image information added with the identification information into gradation information per rotation of the optical disk, and generates the drive information, based on the gradation information.

3. The apparatus according to claim 1, wherein the generating section generates the drive information as a specific area specified by a user's operation, from information stored in a storage area.

4. The apparatus according to claim 1, wherein the generating section adds the identification information to the image information, to form an image of the identification for the image information, on one or both of inner and outer circumferential areas of the optical disk, and transforms the image information into gradation information per rotation of the optical disk.

5. The apparatus according to claim 1, further comprising:
a recording section which records a video signal by irradiating the laser light from the laser radiation section onto a recording layer of the optical disk, from a side opposite the photoimageable layer, in accordance with control information obtained by encoding the supplied video signal; and
a reproducing section which detects reflected light of the laser light by irradiating the laser light onto the recording layer of the optical disk from the laser radiation section of the pickup section and which reproduces the recorded video signal, based on the reflected light.

6. The apparatus according to claim 1, wherein the control section receives plural items of image information, generates and outputs image information, to output the plural items of the image information to a screen, and supplies one item of the image information to the generating section, in accordance with a user's selection.

7. The apparatus according to claim 1, wherein the control section generates and outputs image information, to output plural shapes as candidates for the shape of the image information to a screen, and processes the image information in correspondence with the one of the shapes that is selected by a user.

8. The apparatus according to claim 1, wherein in order to form visualized images in plural colors on the optical disk, in accordance with the image information and the identification information for the image information, the control section controls the laser radiation section in accordance with color information of the image information, to irradiate the laser light onto photoimageable layers of the individual colors, thereby forming a color image according to the image information.

9. An image forming method for an optical disk apparatus comprising a rotation section which rotates an optical disk having a photoimageable layer that is made imageable by laser light, a pickup section having a laser radiation section which irradiates the laser light onto the photoimageable layer, a driving section which drives the pickup section, and an irradiation driving section which supplies a driving current to the laser radiation section to drive the laser radiation section to irradiate the laser light, the method comprising steps of:
receiving image information;
adding identification information for the image information to the image information;
generating drive information for the pickup section and the irradiation driving section, based on the image information; and
controlling the position of the laser light by controlling the driving section as well as gradation of a visualized image by controlling the irradiation driving section, in accordance with the drive information generated by the generating section, to render a visualized image on the optical disk in accordance with the image information and the identification information for the image information.

10. The method according to claim 9, wherein the image information added with the identification information is transformed into gradation information per rotation of the optical disk, and the drive information is generated, based on the gradation information.

11. The method according to claim 9, wherein the drive information is generated, based on image information as a specific area specified by a user's operation, from image information stored in a storage area.

12. The method according to claim 9, wherein the identification information for the image information is added to the image information, to form an image of the identification for the image information on one or both of inner and outer circumferential areas of the optical disk, and the image information is transformed into gradation information per rotation of the optical disk.

13. The method according to claim 9, wherein:
a video signal supplied is recorded by irradiating the laser light onto a recording layer of the optical disk, from a side opposite the photoimageable layer, in accordance with control information obtained by encoding the video signal supplied; and
reflected light of the laser light is detected by irradiating the laser light onto the recording layer of the optical disk, and the video signal recorded is reproduced based on the reflected light.

14. The method according to claim 9, wherein plural items of image information are received, image information is generated and output to output the plural items of the image information, and one item of the image information is supplied in accordance with a user's selection.

15. The method according to claim 9, wherein image information is generated and output to output plural shapes as candidates for the shape of the image information, and the image information is processed in correspondence with the one of the shapes that is selected by a user.

16. The method according to claim 9, wherein in order to form visualized images in plural colors on the optical disk in accordance with the image information and the identification information for the image information, the laser radiation section is controlled in accordance with color information of the image information, to irradiate the laser light onto photoimageable layers of the individual colors, thereby forming a color image according to the image information.

17. An optical disk apparatus comprising:
a rotation section which rotates an optical disk having a photoimageable layer that is made imageable by laser light;
a pickup section having a laser radiation section which irradiates the laser light onto the photoimageable layer;
a driving section which drives the pickup section;
an irradiation driving section which supplies a driving current to the laser radiation section to drive the laser radiation section to irradiate the laser light; and
a control section which receives image information, generates drive information for the pickup section and the irradiation driving section, based on the image information, controls the position of the laser light by controlling the driving section as well as gradation of a visualized image by controlling the irradiation driving section, in accordance with the drive information, renders a visualized image on the optical disk in accordance with the image information, thereafter generates drive information with respect to identification information for the image information in a manner similar to the case of said drive information, and controls each of the sections to render further a visualized image in accordance with the identification information for the image information, on the image of the optical disk.

18. The apparatus according to claim 17, wherein the control section receives plural items of image information, generates and outputs image information, to output the plural items of the image information to a screen, and supplies one item of the image information to the generating section, in accordance with a user's selection.

19. The apparatus according to claim 17, wherein the control section generates and outputs image information, to output plural shapes as candidates for the shape of the image information to a screen, and processes the image information in correspondence with the one of the shapes that is selected by a user.

20. The apparatus according to claim 17, wherein in order to form visualized images in plural colors on the optical disk, in accordance with the image information and the identification information for the image information, the control section controls the laser radiation section in accordance with color information of the image information, to irradiate the laser light onto photoimageable layers of the individual colors, thereby forming a color image according to the image information.
